(19) United States
(12) Patent Application Publication
(10) Pub. No.: US 2005/0034681 A1
(43) Pub. Date: Feb. 17, 2005

(54) Throwable pet toy

(76) Inventor: Rebecca Grose Block, Sarasota, FL (US)

Correspondence Address: Rebecca G. Block, 3850 Malec Circle, Sarasota, FL, 34233, US

(21) Appl. No.: 10/665,031

(22) Filed: Sep. 17, 2003

Related U.S. Application Data
(63) Continuation-in-part of application No. 60/460,388, filed on Apr. 7, 2003.

(51) Int. Cl. A01K 29/00

(52) U.S. Cl. 119/707

(57) ABSTRACT

A circular and molded disc for throwing to a dog for retrieval to the thrower. The disc is of a convex contour when seen from the side. The disc has on its top surface a circular knob to be grasped by the dog for pick-up and retrieval. The knob has a circular and slanting neck between the knob and the disc for a comfortable pick-up by the dog.

### CROSS REFERENCE TO RELATED APPLICATION

This application is a Continuation-In-Part of the Provisional Application No. 60/460.388; filed on Apr. 7, 2003

### STATEMENT REGARDING FED SPONSORED R AND D

(NONE)

### BACKGROUND OF THE INVENTION

This invention relates to a throwable aerodynamic disc, in particular to be thrown by humans to dogs.

U.S. Pat. No. 4,919,083 illustrates such a toy, however the shown construction is quite different from the inventive disc as will be explained below. The disc has a top cross bar which can be grabbed by the dog's mouth and returned to the thrower. However, the cross bar will interfere with the aerodynamics of the disc while rotating in flight which could render it unstable.

U.S. Pat. No. 4,955,842 is a well known disc having a second disc attached to the flat top. It is doubtful if a dog can pick up this disc with its mouth because the flat and second disc is so closely spaced from the first one. The purpose of the second disc on top of the larger one is to retrieve the disc while in flight with a thin blade.

U.S. Pat. No. 5,934,966 discloses an aerodynamic disc to be thrown by humans to a dog for pick up and retrieval. A handle is provided on the underside of the disc so that when the disc lands on any surface, the handle will prevent the disc from completely settling on the ground with the rim edge remaining elevated at least on one side. This is totally different from applicant's device.

### BRIEF SUMMARY OF THE INVENTION

In view of all of the above, the structure of the inventive device will be described below and it will show that the circular knob on top of the disc will make it very easy for the dog to pick up the disc after it has been thrown. The knob is so designed that the lips of the dog will not interfere with the surface of the disc which will greatly enhance the pleasure experienced by the dog. The knob on top of the disc will also not interfere with the aerodynamics of the disc when in flight.

### BRIEF DESCRIPTION OF THE DRAWINGS

FIG. 1 is a perspective and top view of the disc;

FIG. 2 is a side view of the disc;

FIG. 3 is a cross-section through the disc

### DETAILED DESCRIPTION OF THE INVENTION

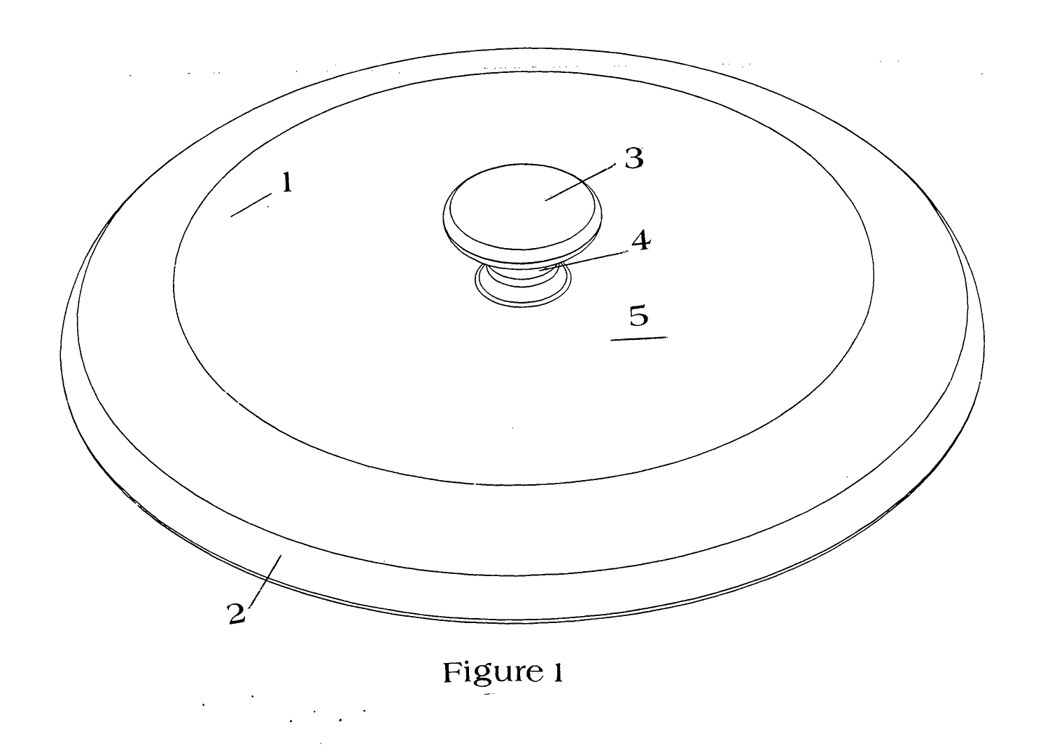

FIG. 1 is a perspective top view of the inventive disc 1. The main top surface is shown at 5 and is flat. The margin of the disc is rounded off and slanted as is shown at 2. The circular knob 3 is integrally molded into the disc as one piece thereof and has a downwardly slanting neck as is shown at 4. The reason for this arrangement to make it easier for the dog to pick up the disc by the knob. The teeth of the dog will encircle the knob below its top and the lips of the dog will rest against the slanting neck below the circular knob. The disc itself may be made of a semi-hardened rubber material so that it is stable while in flight and doesn't flutter in its structure. However the material is most beneficial for the dog's teeth and mouth. Of course, other similar material may be used including the well known hard plastics.

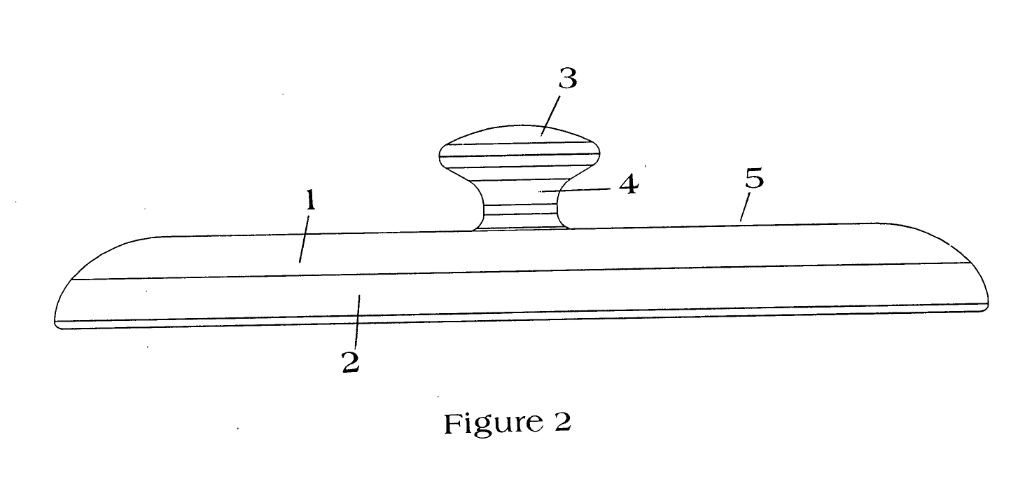

FIG. 2 is a side view of the disc 1 wherein like reference characters are used to identify the same elements of FIG. 1.

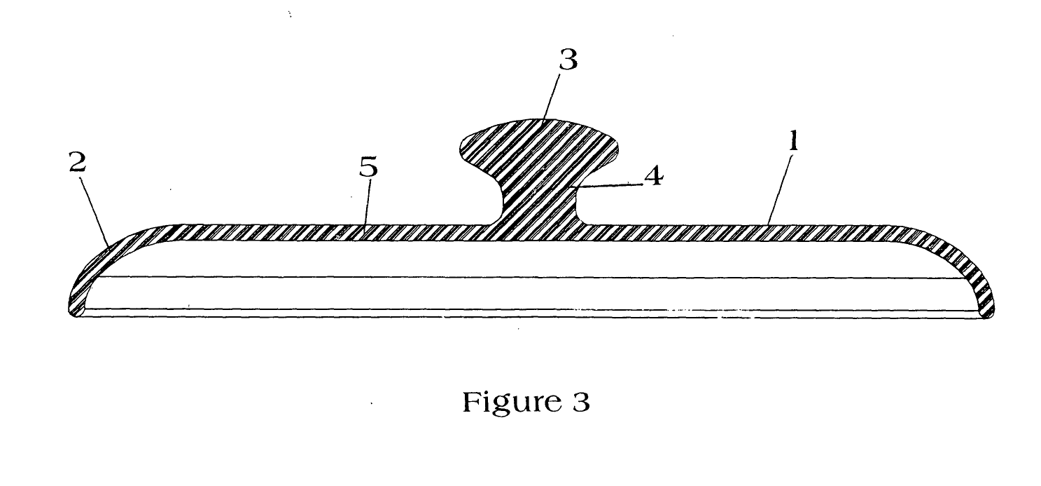

FIG. 3 is a cross-section through the disc 1, again, identifying the same reference characters. What I claim is:

1. A circular disc for retrieval by a dog when thrown, the disc comprising; said disc having a convex contour when seen from the side, a circular knob integrally connected to a top of said disc, a circular and inwardly slanting neck and under said knob connects said knob to said disc, an outer and circular margin of said disc is rounded downwardly to complete the convexity of said disc.

2. The circular disc of claim 1, wherein said disc has a flat area on a top of surface.

3. The disc of claim 1, wherein said knob is integrally molded with said disc.
